(19) United States
(12) Patent Application Publication
(10) Pub. No.: US 2005/0259914 A1
(43) Pub. Date: Nov. 24, 2005

(54) Photonic switch working in momentum-division-multiple-access (mdma) mode for microwave and optical wavelengths based upon the measurement of the spin, the orbital angular momentum and the total angular momentum of the involved photo

(75) Inventors: Miles J. Padgett, Glasgow (GB); Johannes Courtial, Glasgow (GB); Jonathan G. A. Leach, Glasgow (GB); Kenneth D. Skeldon, Glasgow (GB); Sonja Franke-Arnold, Glasgow (GB); Stephen M. Barnett, Glasgow (GB); Charles N. Ironside, Glasgow (GB)

Correspondence Address: NIXON & VANDERHYE, PC, 901 NORTH GLEBE ROAD, 11TH FLOOR, ARLINGTON, VA, 22203, US

(73) Assignees: THE UNIVERSITY COURT OF THE UNIVERSITY OF GLASGOW, Glasgow (GB); THE UNIVERSITY OF STRATHCLYDE, Glasgow (GB)

(21) Appl. No.: 10/516,335

(22) PCT Filed: May 29, 2003
(86) PCT No.: PCT/GB03/02314

§ 371 Date: May 31, 2005

(30) Foreign Application Priority Data
May 30, 2002 (GB) 0212551.6

(51) Int. Cl. G02B 6/26

(52) U.S. Cl. 385/16

(57) ABSTRACT

Photonic switch working in Momentum-Division-Multiple-Access (MDMA) mode for microwave and optical wavelengths based upon the measurement of the spin, orbital angular momentum and total angular momentum of the involved photons. For the optical wavelengths Dove prisms and holograms are used in form of a Mach-Zehnder-Interferometer as selectors; for the microwave wavelengths phased-array antennas with double orthogonal dipoles act as selectors.

### FIELD OF INVENTION

The present invention relates to an improved electro-magnetic device such as an optical device, and related method and apparatus, e.g. for use in improved optical communications or processing. In particular the invention relates to a device, method and apparatus which utilises at least the orbital angular momentum (OAM) of an electro-magnetic beam or photons to allow a plurality of states of information to be transmitted, e.g. optically. Similarly, at least the orbital angular momentum can be used to define a plurality of communication/information channels, and thus achieve a multiplexed communication/information system.

### BACKGROUND TO INVENTION

It is known that photons can carry both spin and orbital angular momentum. The spin which a photon carries is associated with the polarisation of the photon, and the orbital angular momentum is associated with the azimuthal phase of the complex electric field. The polarisation of a single photon is described by a state in two-dimensional space, the Eigen values of which are ± [symbol] , or more simply can be considered as right hand spin and left hand spin. Photon polarisation provides a useful physical realisation of a single qubit and is widely employed in demonstrations of quantum key distribution. However the measurements of the polarisation, that is identification of right hand spin or left hand spin, only provide for the transmittal of one bit/piece of information by a photon, that one bit/piece of information only providing a bi-state result, for example, left and right which could be interpreted as yes and no respectively. Therefore, in terms of optical communication, the information which can be carried by a single photon is limited when read out is reliant on the spin of the photon.

It has been noted, however, that the infinite number of orthogonal states of orbital angular momentum places no limits on the number of bits of information that can be carried by a single photon. Furthermore, the ability to create states with different orbital angular momenta and superpositions of these states allows the realisation of quNits that is the quantum states in an N-dimensional space with single photons. However, at the moment it is only possible to identify the value of orbital angular momentum when a plurality of photons possessing the orbital angular momentum is made to interfere. Using an arrangement such as that shown in FIG. 1, which is a Mach-Zehnder interferometer with a Dove prism inserted into one arm, input light interferes with its own mirror image. In the case of light with l intertwined helical phase fronts the interference pattern has 2l radial fringes. In the arrangement shown, l=2 and therefore 4 fringes can be seen. This arrangement allows an arbitrary number of states to be distinguished between but in order to form the required fringe pattern, many photons are needed.

In FIG. 2 there is shown a prior art arrangement which can identify orbital angular momentum at a single photon level. In this arrangement the photons having orbital angular momentum, which in this case is l=2, are projected through a l=−2 hologram. This hologram allows phase fronts of the light modes, if l=2 to be flattened. This means the beam, now with planar phase fronts can be focussed through a pin hole behind which is positioned a detector. As only l=2 light modes will be flattened by the l=−2 hologram, no light will be transmitted through the pinhole, and therefore no light detected, if l takes any other value, i.e. l≠2. Whilst this arrangement works at a single photon level, it can only test for one particular state of orbital angular momentum. Therefore, this arrangement is such that it is only possible to achieve a bi-state result, that is only the question “Does l=x?” (where x equals one of −n, . . . , −3, −2, −1, 0, 1, 2, 3, . . . , n) can be considered the answer to which can only be yes or no.

An object of at least one embodiment of at least one aspect of the present invention is to obviate or at least mitigate at least one of the aforementioned problems.

A further object of at least one embodiment of at least one aspect of the present invention is to provide a means for determining, at a single photon level, a value of orbital angular momentum possessed by the photon, providing a multi-channel device for determining the orbital angular momentum of a single photon.

### SUMMARY OF INVENTION

According to a first aspect of the present invention there is provided a device comprising:
at least one input;
at least one output;
means for selecting at least one of the at least one outputs, wherein the selection is dependent upon at least an orbital angular momentum of at least one input electro-magnetic energy input or appearing at the at least one input, in use.

Preferably there may be provided a plurality of inputs.

The orbital angular momentum is taken in this aspect to mean the property of the at least one electro-magnetic energy such that upon rotation about an axis of the energy a phase shift is introduced.

The at least one electro-magnetic energy may comprise at least one electro-magnetic signal or beam.

The electro-magnetic energy may comprise a photonic energy, e.g. at least one photon.

The means for selecting may comprise means for directing or switching the at least one electro-magnetic energy to the selected at least one of the at least one outputs.

The selected at least one of the at least one outputs may comprise one of the plurality of outputs.

An output electro-magnetic energy may, in use, appear at the selected at least one of the at least one outputs.

The output electro-magnetic energy may comprise at least part of the at least one electro-magnetic energy.

The device may be particularly adapted for use at optical wavelengths or frequencies, e.g. far infra-red to far ultra-violet. Alternatively, the device may be adapted for use at radio frequencies or in the millimetre wave or microwave regions, e.g. including frequencies from a few kilohertz to hundreds of GHz.

The device of the present invention may be used as a switching or multiplexing device.

The electro-magnetic signal may comprise at least one photon.

Alternatively, the electro-magnetic signal may comprise a beam.

According to a second aspect of the present invention there is provided an electro-magnetic device such as an optical device comprising:
at least one input;
a plurality of outputs;
means for directing at least one electro-magnetic signal or photon from the input to a selected of the outputs, the selection being dependent upon at least an orbital angular momentum of the/each at least one electro-magnetic signal or photon.

The orbital angular momentum is taken in this aspect to mean the property of an electro-magnetic signal, photon or beam, such as a light beam, such that upon rotation about a signal/photon/beam axis a phase shift is introduced.

The selection may be dependent upon:
orbital angular momentum, l(OAM) solely;
orbital angular momentum and spin angular momentum, s (SAM) individually; or
orbital angular momentum and spin angular momentum combined (i.e. total angular momentum, j).

Preferably the means for directing comprises at least one interferometer.

Preferably the or each interferometer may include means for inducing, in use, a rotation or invertion of an electro-magnetic mode of an electro-magnetic signal such as light mode of a photon in at least one arm of the interferometer.

Preferably the means for inducing a rotation comprises at least a first prism and a second prism. Conveniently at least one prism may be positioned in each arm of the interferometer.

Alternatively the first prism and second prism may be positioned in one arm of the interferometer.

Conveniently the at least first prism positioned in a first arm of the interferometer is rotated with respect to the at least second prism positioned in a second arm of the interferometer.

In this arrangement, the term rotated is used to denote that the second prism is turned through an angle of a around the second optical path, with respect to the orientation of the first prism in the first optical path.

Preferably the at least first prism and second prism introduce a phase shift in each passing photon.

Conveniently each prism is a Dove prism. Dove prisms act to cause an inversion of a transverse cross-section of an optical beam transmitting through the prism.

Conveniently the optical device comprises a one piece device and is preferably a monolithic block.

The device may include means for rotation of a polarisation state (and hence spin angular momentum) of a photon or photons.

The means for rotation may allow an output of the device to be determined by total angular momentum of a photon or photons, not solely OAM.

The means for rotation may be at least one half-wave retarder. Alternatively the means for rotation may be at least one quarter wave retarder.

Conveniently the means for rotation may be disposed within the or each interferometer.

Alternatively the means for rotation may be disposed outwith the or each interferometer.

According to a second aspect of the present invention there is provided an optical device comprising:
an input;
a first beam splitting means;
a second beam splitting means;
a first reflective means;
a second reflective means;
a first prism;
a second prism; and
at least a first output and a second output,
wherein the first beam splitting means, the second beam splitting means, the first reflective means, and the second reflective means are arranged to form an interferometer arrangement, with the first prism disposed in a first arm of the interferometer arrangement and the second prism disposed in a second arm of the interferometer arrangement, the input leading to the first beam splitting means and the at least first output and second output leading from the second beam splitting means, and wherein, in use,
at least one photon is input into the device which determines or selects, based on an orbital angular momentum of the photon, the output to which the photon will pass. Preferably the first prism is rotated with respect to the second prism.

Preferably the first prism and second prism introduce a phase shift in the or each passing photon.

Conveniently each prism is a Dove prism.

Conveniently the optical device comprises a one piece device, which is preferably a monolithic block.

According to a fourth aspect of the present invention there is provided an apparatus such as an optical apparatus comprising a plurality of cascaded devices such as optical devices according to the first, second or third aspects of the present invention, wherein the devices are arranged with an at least one output of one device communicating with another device. For example, one optical device optically communicating with another optical device.

The apparatus may comprise a signal processing apparatus, such as optical signal processing apparatus. Preferably a hologram may be disposed between an output of the one optical device and an input of the other optical device.

Conveniently, in use, the hologram acts to increase the orbital angular momentum of the or each photon which passes through the hologram.

According to a fifth aspect of the present invention there is provided a system such as an optical system including at least one device or apparatus, such as a optical device or optical apparatus according to the first, second, third or fourth aspects of the present invention.

Preferably, the optical device or apparatus provides the system with at least two possible output groups of output photons or states, the groups or states being selected by the optical device or apparatus depending on an orbital angular momentum feature of the input photon.

Preferably the system further comprises a detector arrangement to detect a state of at least one output of the optical device or apparatus.

Preferably the optical system is an optical communications system, and preferably a free space optical communication system.

It will be appreciated that although the device/apparatus/system of the present invention may be adapted for use at any suitable wavelength within the electromagnetic spectrum, the device/apparatus/system may be adapted for use in the near infra-red spectrum or visible spectrum, particularly 700 nm to 3 μm, and most preferably 1.3 μm to 1.6 μm.

According to a sixth aspect of the present invention there is provided a method of determining a feature of orbital angular momentum of an electro-magnetic energy, such as a or each photon, e.g. in an optical signal, the method comprising the steps of:
providing a device, such as an optical device comprising:
at least one input;
a plurality of outputs;
means for directing an electro-magnetic energy, such as at least one photon, from the input to a selected of the outputs, the selection being dependent upon an orbital angular momentum of the electro-magnetic energy, such as the/each at least one photon;
inputting the electro-magnetic signal into the device;
detecting a feature of the orbital angular momentum of the electro-magnetic energy;
directing the electro-magnetic energy to a selected one of a plurality of outputs, the selected output for the electro-magnetic energy being selected by the detected property of the electro-magnetic energy.

According to a seventh aspect of the present invention there is provided a method of communication or signal processing such as optical communication or signal processing, the method comprising the steps of:
providing a detection system, such as an optical detection system, comprising at least one device, such as an optical device, and a detection means;
receiving at least one electro-magnetic energy or signal, such as at least one photon;
passing the at least one electro-magnetic energy through the detection system comprising at least one device so as to determine an orbital angular momentum of said at least one electro-magnetic energy;
directing the at least electro-magnetic energy from the device to the detection means so as to identify said feature of orbital angular momentum of said electromagnetic energy.

Preferably the method further comprises the steps of: providing at least one transmission system such as an optical transmission system; and
transmitting at least one electro-magnetic energy, such as one photon, to be received by said detection system.

According to an eighth aspect of the present invention there is provided a prism, the prism comprising:
an input;
an output; and
   means for inverting a transverse cross-section of an optical beam or light mode transmitted through the prism without changing the polarisation state.

Preferably the input and the output are normal to an optical beam transmission axis. Preferably the prism is formed of optical quality glass, in particular it may be formed of BK7.

According to a ninth aspect of the present invention there is provided a prism comprising:
a first end face; and
a second end face, arranged substantially parallel to said first end face; and
a side face, disposed between said first end face and said second end face, the side face being formed of two planar areas disposed in a inwardly orientated ‘V’ shape.

In this arrangement, inwardly orientated is used to identify the orientation of the face with respect to the body of the prism.

Conveniently the prism acts to invert a transverse cross-section of an optical beam transmitted through the prism.

Conveniently the prism is polarisation insensitive when an optical beam is input to the prism via an end face.

According to a tenth aspect of the present invention there is provided an optical device comprising two prisms according to the ninth aspect of the present invention.

Preferably the device further comprises two beam splitters.

Conveniently the device is a block unit, with planar faces of each component allowing each component to be arranged directly adjacent each other component.

Conveniently the block unit is a monolithic block.

Preferably a plurality of said devices are cascaded to form an optical apparatus.

Preferably an optical communication system or signal processing system may be formed using said optical device or optical apparatus.

According to an eleventh aspect of the present invention there is provided a phased-array antenna adapted to generate or form an electro-magnetic energy, signal or beam with angular momentum.

According to a twelfth aspect of the present invention there is provided use of a phased-array antenna to generate or form an electro-magnetic energy, signal or beam with angular momentum.

According to a thirteenth aspect of the present invention there is provided a phased-array antenna adapted to detect angular momentum in or of an electro-magnetic energy, signal or beam.

According to a fourteenth aspect of the present invention there is provided use of a phased-array antenna to detect angular momentum in or of an electro-magnetic energy, signal or beam.

According to a fifteenth aspect of the present invention there is provided a method of communication or signal processing using electro-magnetic energies, signals or beams, the method comprising:
multiplexing using angular momentum of electro-magnetic beams by generating and sensing using phase differences in arrays of antenna.

### BRIEF DESCRIPTION OF DRAWINGS

These and other aspects of the present invention will be described, by way of example only, with reference to the following description when taken in combination with the accompanying drawings which are:

FIG. 1 a schematic representation of a first prior art system for measuring orbital angular momentum of light;

FIG. 2 a schematic representation of a prior art system for identifying a particular value of orbital angular momentum of photons;

FIG. 3(A) a schematic representation of an unrotated phase structure;

FIG. 3(B) a schematic representation of the phase structure of FIG. 3(a) having been rotated;

FIG. 4 grayscale representations of phase profiles of non-rotated and rotated light beams;

FIG. 5 a schematic representation of a device for detecting orbital angular momentum according to a first embodiment of the present invention;

FIG. 6 a schematic representation of sorting stages of an optical apparatus including a plurality of devices of FIG. 5;

FIG. 7 photographic images of experimental results obtained using the device of the first embodiment of the present invention;

FIG. 8 photographic images of experimental results obtained at single photon level using the optical apparatus of FIG. 6;

FIG. 9 a schematic representation of an optical communication system including an optical device or apparatus of the present invention;

FIG. 10 a schematic representation of a device according to a second embodiment of the present invention;

FIG. 11 photographic images obtained using the device of FIG. 10;

FIG. 12 a schematic representation of a prism suitable for use in a device of the present invention;

FIG. 13 a schematic representation of a device according to a third embodiment of the present invention.

FIG. 14 a schematic representation of a device according to a fourth embodiment of the present invention;

FIG. 15 a phased-array for forming an electromagnetic beam with angular momentum comprising a part of a system according to a further embodiment of the present invention;

FIG. 16 a phased-array for detecting the angular momentum of an electro-magnetic beam comprising a further part of the system according to the further embodiment of the present invention;

FIG. 17 a phased-array for transmitting/detecting an electro-magnetic beam with angular momentum comprising a part of a system according to a yet further embodiment of the present invention;

FIG. 18 a block diagram of processing steps for a received beam or signal in the system according to the yet further embodiment of FIG. 17; and

FIG. 19 a schematic block diagram of part of the processing steps of FIG. 18.

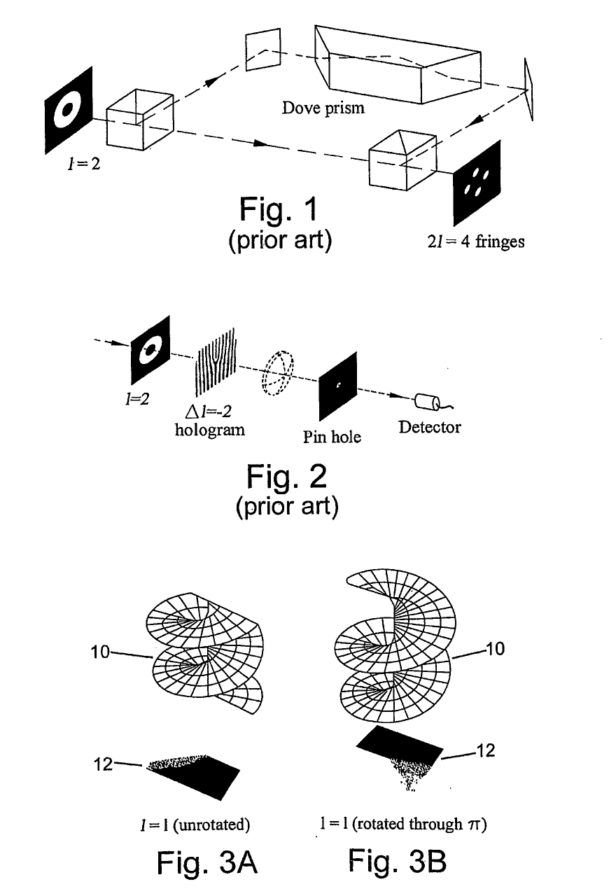

### DETAILED DESCRIPTION OF DRAWINGS

An azimuthal phase ramp of a transverse cross section of wave fronts result in surfaces of constant phase that are shaped like helices. With references to FIG. 3(A), there is shown a schematic representation of the phase structure, from 0 to 2π of a lightmode which has an orbital angular momentum of l=1 and an exp(ilφ) phase structure. As can be seen the phase structure 10 has a spiral-type form which in this case comprises, as l=1, a single helix. Below this, is illustrated a grey scale projection 12 of the phase front which is indicative of the single helix structure, with only one leading edge visible.

In FIG. 3(B), there is illustrated the spiral phase structure of FIG. 3(A) upon having been rotated through π. As can be seen, the π rotation results in the projection of the phase front of the structure, now exp(il(π+φ)), being out of phase by lπ with the non-rotated projection. The phase structure when l=1 therefore requires a 360° rotation before repeat symmetry would be achieved.

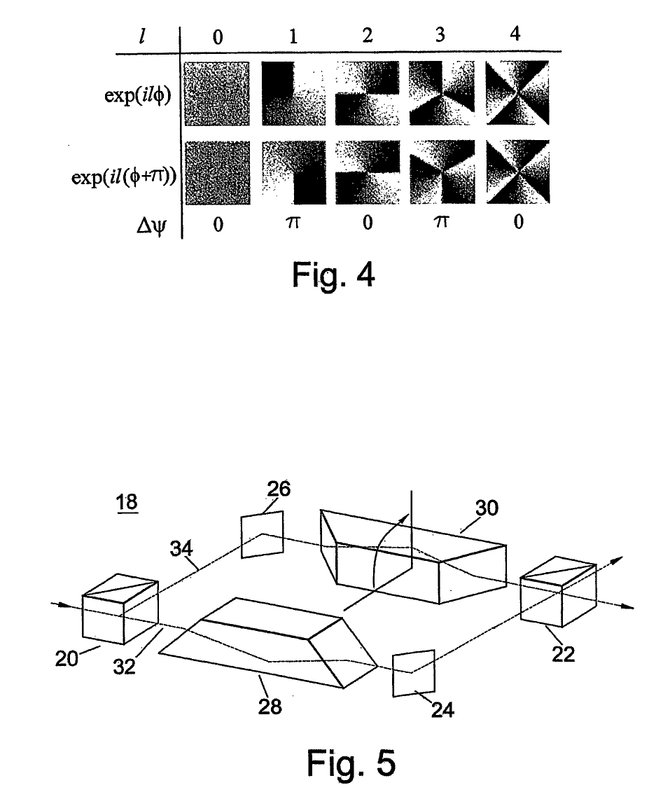

In FIG. 4, there is illustrated a comparison of transverse phase cross-sections for rotated, and non rotated beams having l=0, 1, 2, 3 and 4. The upper row of cross sections illustrate the exp(ilφ) phase front structure for each of the orbital angular momentum values. The lower row of cross sections show the corresponding exp(il(π+φ)) phase front structure for the orbital angular momentum values=0, 1, 2, 3 and 4 upon rotation of the phase front through π. The bottom line of the chart, which illustrates ΔΨ, shows that for even values of l, rotational symmetry is achieved at 180°. However, for odd values of l, the rotated beam is out of phase, by π, with the non-rotated beam after a rotation through π.

In FIG. 5 there is shown a first embodiment of an optical device, which, in this case, comprises a Mach-Zehnder interferometer and two Dove prisms. In particular the device 18 comprises a first beam splitter 20, a second beam splitter 22, a first mirror 24, a second mirror 26, a first Dove prism 28 and a second Dove prism 30.

A beam which is input into the device 18 enters the first beam splitter 20 where it is split, one part of the beam being transmitted along optical path 32 through the first Dove prism 28 after which it is reflected from the second mirror 26 before passing through the second beam splitter 22. The second part of the beam is transmitted along optical path 34, and reflects off the first mirror 24 before passing through the second Dove prism 30 after which it transmits through the second beam splitter 22.

A Dove prism, such as prisms 28 and 30 in the device 18 inverts the transverse cross section of any beam transmitted through the prism. Therefore the inclusion of a Dove prism 28, 30 on each optical path 32, 34 with the second Dove prism 30 being rotated through an angle of α/2 with respect to the first Dove prism 28 has the effect of rotating a passing optical beam through an angle of α. In the arrangement illustrated, α/2=π/2, and hence the relative phase difference between the two optical paths 32, 34 of the interferometer is Ψ=lπ. By adjusting the path length of the interferometer arrangement accordingly, photons with even l are output from beam splitter 22 along optical path A1, and photons with odd l are output from beam splitter 22 along optical path B1. If the input state of photons input into the device 18 is a mixture of even and odd l components, then these components are “sorted” into an even channel and an odd channel when output.

In this device 18, the orbital angular momentum measurement ‘sorts’ exp(ilφ) according to the value of l, relying on the exp(ilφ) phase structure of the transverse mode of the photon. As shown in FIGS. 3(A), 3(B) and 4, on rotation of the beam through an angle α, this dependence becomes exp(il(φ+α)). This corresponds to a phase shift of Ψ=lα which is a manifestation of a geometrical phase. For particular combinations of l and α the rotated beam may either be in or out of phase with respect to the original phase of the beam. For example, when α=π a beam with even l is in phase with the original phase but a beam with odd l rotated by the same angle is out of phase by π. By incorporating this rotation into the arms of a two-beam interferometer which forms the basis of device 18, the phase shift between the two arms becomes l-dependent. This means that for different angles of rotation, constructive and destructive interferences occurs for different values or classes of l which is exploited as detailed by the insertion of Dove prisms into the arms of the interferometer.

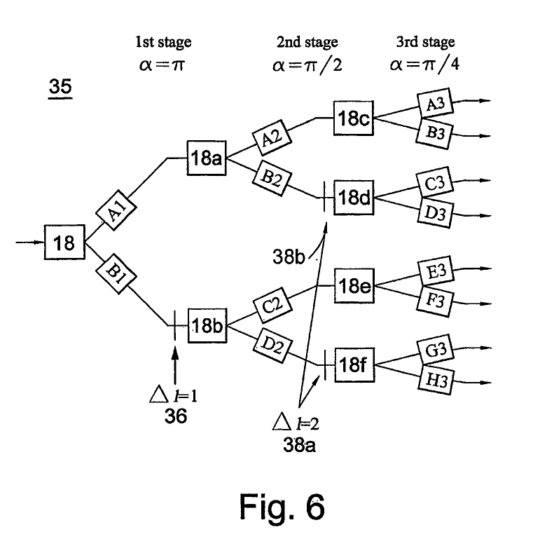

In order to extend this device further to provide a multi channel output, an optical apparatus can be formed of a plurality of devices 18. In such an apparatus, each device is as described with reference to FIG. 5, a first device having a beam input into it, in use, and further devices being cascaded from the first device. In each of these cascaded devices, different-rotation angles would be implemented and schematic illustrations of such a cascaded arrangement is shown in FIG. 6.

In the illustration of FIG. 6, there is shown the first three stages of the “sorting” scheme of an optical apparatus 35 comprising three layers of cascaded devices. Each device 18 has two outputs, Ax and Bx respectively. The device 18 of the first ‘sorting’ stage comprises Dove prisms rotated to introduce a phase shift of α=π and therefore the outputs along optical paths A1 and B1 respectively are sorted in multiples of two, that is even values of l are output along optical path A1 and odd values of l are output along optical path B1.

If we then follow the transmission of odd l photons these are passed through a l=1 hologram 36, which is generated using standard photographic techniques so that they become even l photons. The inclusion of the l=1 hologram is necessary as each device ‘sorts’ even and odd multiples of powers of 2; this means that in order for the photons output along B1 which currently have l= . . . −1, 1, 3, 5, . . . etc to undergo a further ‘sorting’ stage a value of 1 must be added, or alternatively subtracted, to each odd value, resulting in l= . . . 0, 2, 4, 6, . . . etc. The device 18b through which these photons then pass on the second stage, introduces a phase shift of α=π/2. Due to this phase shift means that this device 18b can thus sort the input even l photons into even and odd multiples of two, with even multiples of two being output along optical path C2 and odd multiples of 2, that is l=2, 6, 10 . . . etc, being output along D2.

At the third cascade stage, l=2 holograms 38a and 38b are placed in the optical paths B2 and D2, respectively, resulting in the odd multiples of 2 being converted into even multiples of 2 to allow a further sorting stage to be implemented. When considering the photons travelling along optical path B2, after passing through the hologram 38b, such photons then pass into unit 18d where a phase shift of α=π/4 is introduced due to the rotation of the Dove prisms in device 18d. Yet again, the photons are sorted into a further stage of odd and even classes of values of l in this case odd and even multiples of 4, with even multiples of 4 being output along C3, and odd multiples of 4 being output along optical path D3. As can be seen, each of the other output optical paths from devices 18a, 18b are treated similarly by passing through at least one further device, and therefore, by the end of the transmission through the apparatus 35, an 8 channel output is obtainable.

By adding further cascading stages to the apparatus, this procedure can be extended to allow an arbitrarily large number of orbital angular momentum states to be distinguished.

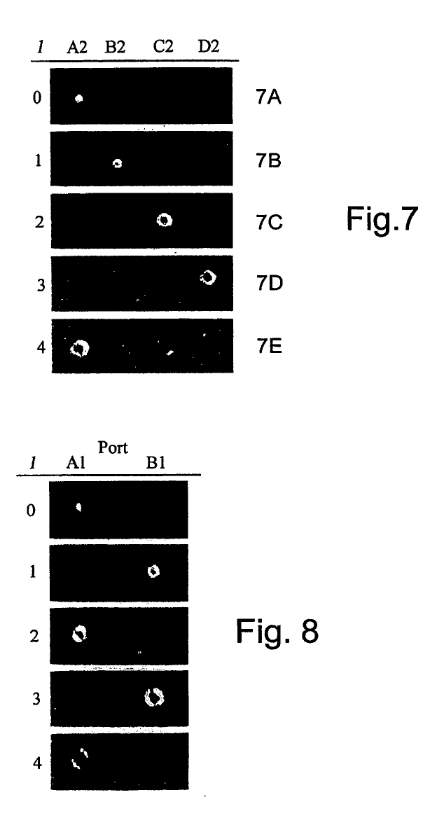

In FIG. 7 experimental results achieved using a apparatus having two cascaded stages of devices 18 are illustrated. These photographic results were achieved with the light source input into the arrangement being a helium-neon laser with a power of less than 1 mW. An intercavity cross-wire introduced rectangular symmetry to the laser cavity and forced the laser to oscillate in high order Hermite-Gaussian (HG_{m,n}) modes. Such modes are characterized by the indices m and n which correspond to zeros of intensity in the electric field in the x and y directions, respectively. The Hermite-Gaussian (HG_{m,n}) modes were then converted into Laguerre-Gaussian by passing them through a π/2 mode converter based on cylindrical lenses. The resulting Laguerre-Gaussian modes had an exp(ilφ) phase structure and corresponding OAM of l [symbol] per photon. This conversion of Hermite-Gaussian beams give Laguerre-Gaussian (LG_{m,n}) beams characterized by l=↑m−m| and p=min (m,n) Adjustments to the intracavity cross wire allowed generation of HG_{n,0} with m=0, 1, 2, . . . , which in turn gives rise to LG₁₀ beams with 1=0, 1, 2, . . . . Each arm length of the unit 18 is approximately 30 cm and comprises standard optical components as detailed previously.

The l=1 hologram 36 was manufactured using standard photographic techniques, and such a hologram 36 increases the l value of any exp(ilφ) mode by 1. The four output paths A2a, B2a, A2b, B2b of the system were directed onto a screen so that a camera could take an image of the output and the images generated are shown as images 7A, 7B, 7C, 7D and 7E respectively. As can be seen, the modes from l=0 to l=4 have been sorted into different output paths with the l=4 image appearing at the same port as the l=0 beam as would be expected due to the 2 stage nature of the device.

In FIG. 8, there is shown photographic results which were achieved by operating a one stage system at a single photon level. Achieving a single photon operating level required using light having an intensity so low that on average less than one photon is present in each unit at any one time. This light intensity level was, in this case, achieved by inserting neutral-density filters to attenuate the power of the laser beam being input into the device to less than 0.3 nW. The experiment which generated the results of FIG. 8 was carried out using a one stage device with the output ports of the device being directed into a camera that averaged over a number of frames. As can be seen, this device sorted between odd and even l with an efficiency limited only by the quality of optical components.

The orbital angular momentum sorting device, as detailed above, could be considered to be the analogue of a polarizing beam splitter in that it selects an optical path on the basis of the orbital angular momentum with one path for each of the distinguishable states. It is in this way that the orbital angular momentum sorter can be used to create entanglement between the optical path and orbital angular momentum in the same way that a polarising beam splitter can create entanglement between the optical path and polarisation. Such orbital angular momentum sorting apparatus can, therefore, generate highly entangled states and extend the optical realisation of quantum logic elements to orbital angular momentum quNits.

Furthermore, it can be seen that single photons in an orbital angular momentum eigenstate can be measured in any one of a number of different orthogonal states corresponding to different values of l, with the orbital angular momentum in units of [symbol] . The only limit to efficiency of the device or apparatus is the efficiency of the components. The ability to measure a single photon to be in any one of an arbitrarily large number of orthogonal states provides a useful tool in quantum information processing. The efficient measurement of the orbital angular momentum of a single photon allows access to a larger state space than that associated with optical polarisation. This means a greater density of information transfer, along with generation and analysis of entanglement, involving large numbers of states, is able to be utilized. Therefore, entanglement based applications, such as superdense coding, teleportation, and quantum computation, can all be improved due to the efficient measurement of the orbital angular momentum of a single photon.

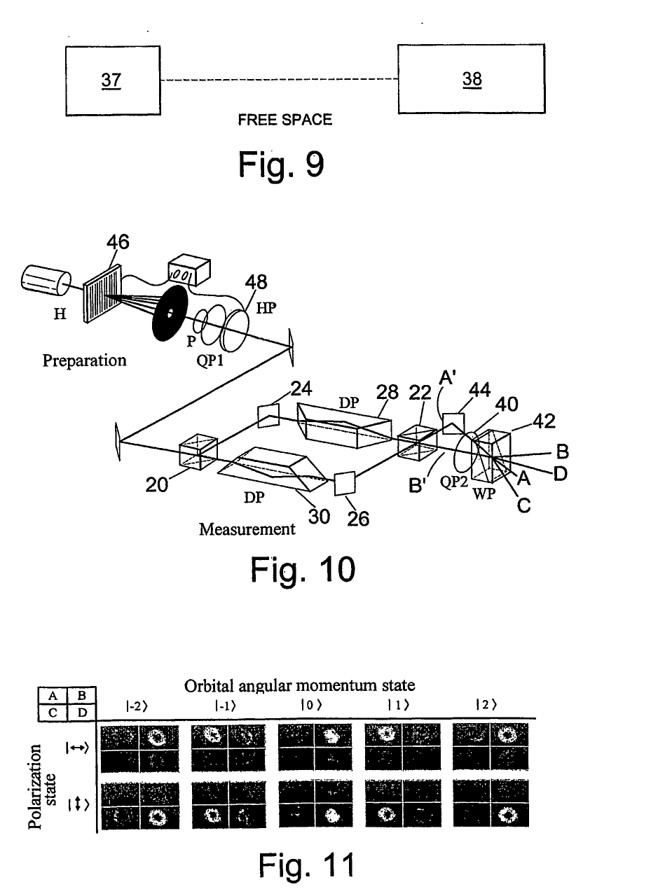

In particular an optical communication system, such as that shown in FIG. 9, can be constructed involving the optical device, or optical apparatus as described above. Such a communication system would be arranged to ‘sort’ between a predetermined number of states. Information encoded using the predetermined number of states would be transmitted by the optical transmission means 37 to be received by an optical detection means 38, comprising an optical device or optical apparatus as detailed above. The information would then be decoded providing the original data.

In a modified embodiment of the device 18 according to the present invention, illustrated schematically in FIG. 10, a quarter wave plate 40 and a prism 42 are disposed at the output path of the device, a mirror 44 disposed at the A output path directing the A output through the ¼ wave plate and prism 42.

By passing the outputs of the output paths A′ and B′ of the device 18 through a quarter wave plate 40 and a prism 42, the resulting path of the photon also becomes dependent upon the spin angular momentum (SAM) state. This device 18 results in four outputs ports A, B, C and D, each of which corresponds to a possible combination of spin+1/spin−1 (i.e. left hand/right hand polarisation) states and orbital even/odd states. In this arrangement there is also shown a preparation stage to the device 18 which comprises a computer hologram 46, polariser 47, quarter wave plate QP1, and an electronically controlled half-wave plate 48. The polariser 47 measures the light input by lasers L, i.e. pure linear polarised light. The quarter wave plate QP1 determines the polarisation state of the optical beam entering the device 18; in this case circularly polarised light is transmitted. The half wave plate (HP1) 48 allows switching between +1 and −1 polarisation state for the input of light. This preparation stage allows the rapid selection between both the orbital angular momentum and polarisation states of the photons before such enter the sorting device 18. The ‘sorting’ device 18 comprises standard optical components namely a first beam splitter 20, a first mirror 24, a second mirror 26, a first Dove prism 28, a second Dove prism 30, and a second beam splitter 22, all of which are standard optical components. In this case the length of each arm of the interferometer arrangement of the device 18 is approximately 100 mm long. The light source used was a helium-neon laser L with an output at 633 nanometres and a power of less than 1 mW. Neutral density filters were used to attenuate the power in the beams so that such corresponds to an average of one photon or less in the interferometer at any time. The output ports of the device 18 are then directed into a camera that averages over 24 frames per second, so that an intensity pattern can be recorded.

In FIG. 11 the output from the orbital angular momentum and linear polarisation sorting process as performed by the device arrangement of FIG. 9 can be seen. As can be seen, the even and odd orbital angular momentum states have been sorted and simultaneously the horizontal and vertical linear polarisation states have been sorted into different output paths. The contrast of each channel was measured as a ratio of 10:1 and absolute efficiency of the device was 50%.

This technique can be extended further giving an arbitrarily large number of orbital angular momentum state results. This can be achieved, as detailed before, by cascading additional devices each having been provided with different rotation angles by virtue of the prisms included in the devices.

It should be understood that in each of the arrangements shown above higher contrast in output readings may be achieved by more rigidly designing the interferometer, and a higher absolute efficiency can be achieved with better quality and specifically designed optical components.

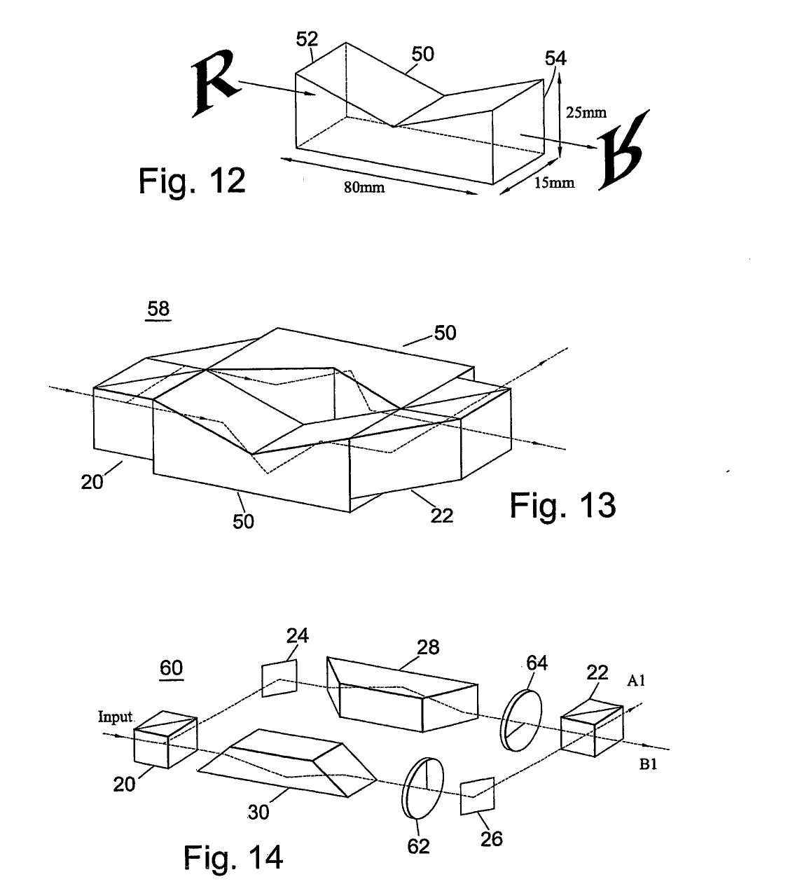

The device of the present invention can be further improved by utilising a prism as shown in FIG. 12, in place of the known Dove prism arrangement, in the arms of the interferometer of the device.

As can be seen this prism 50 is provided with perpendicular edges 52, 54 thus allowing the prism 50 to be combined with beam splitters in a manner which allows the interferometer based devices or units 18 to be built in the form of a monolithic block. Such a monolithic device 58 according to a third embodiment of the present invention is shown in FIG. 13. Furthermore, the prism 50 is polarization insensitive as the incident beam input into the prism 50 is normal to the prism surface 52.

The device 58, shown in FIG. 13, which is formed using two prisms 50, can be used in each stage of the orbital angular momentum ‘sorter’ apparatus with the monolithic block device 58 being a more stable form of interferometer based device. Translational and angular displacement of the block device allows for the interferometer of the device to become aligned without the use of mirrors.

With reference to FIG. 14, there is shown a fourth embodiment of an optical device which allows the total angular momentum of an optical beam to be determined by the device. This device 60 comprises first beam splitter 20, first mirror 24, second mirror 26, first Dove prism 28, second Dove prism 30, and second beam splitter 22. The device further includes a first half wave plate 62 and second half wave plate 64 which act to rotate the polarisation/spin angular momentum state of the light mode. The phase shift between the two arms of the interferometer thus becomes depended on the total angular momentum. This device therefore ‘sorts’ according to the total angular momentum.

The conceptual background to using angular momentum in an optical beam as a means of conveying information is clear from the foregoing. In the foregoing, the techniques described for generating and detecting electromagnetic beams with angular momentum were appropriate for the optical region of the electromagnetic spectrum. In this further embodiment, techniques for generating and detecting electromagnetic beams appropriate to the radio frequency, microwave and millimetre wave region (frequencies from a few tens of kilohertz to several hundred gigahertz) are described. The usefulness of angular momentum of electromagnetic beams for communication or signal processing systems described hereinbefore carries over from the optical part of the electromagnetic spectrum to other regions of the electromagnetic spectrum.

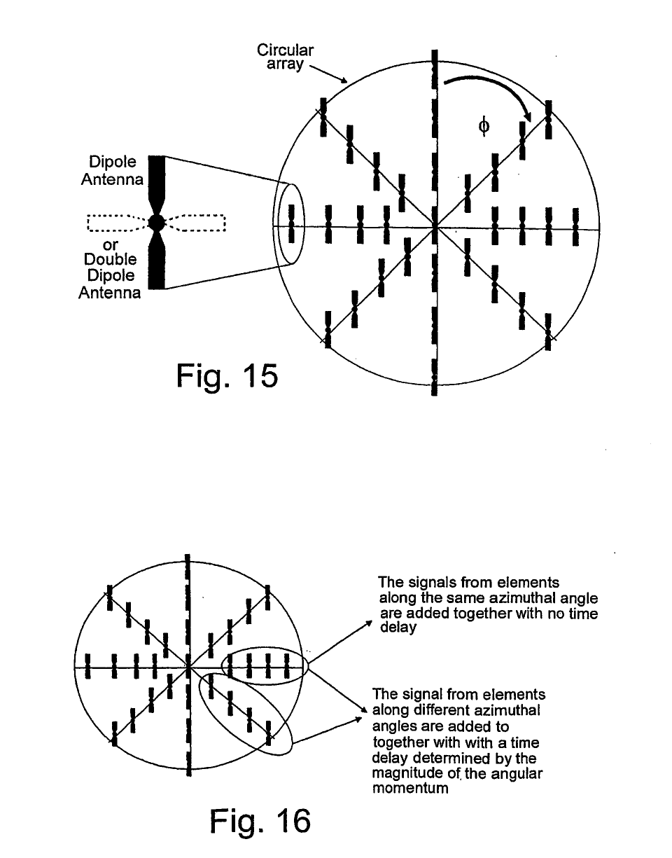

FIG. 15 illustrates a phased-array which consists of individual elements in a circular clock-face arrangement. Each element (shown in this particular embodiment as half wave dipoles) in the array is fed a separate signal; the phase relationship between the signals determines the angular momentum imparted to the beam that is formed by the phased array. The phase relationship between the signals is such that each element along the same azimuthal angle has the same phase, but for elements of the not along the same azimuthal angle there is a phase delay between the signals feeding the elements. The phase delay is a function of the azimuthal angle, Φ and the relationship between the angular momentum, l, imparted to the beam and the phase delay, d, is given by:
D=lΦ

Referring now to FIG. 16, there is a similar array for detecting angular momentum of an electromagnetic beam, the array being similar to the generating array, and can be employed to detect angular momentum in a received electromagnetic beam. When an electro-magnetic wave is detected by the receiving array a separate signal is detected in each of the elements of the array. In order to detect any angular momentum present in the received electro-magnetic beam, a certain proportion of the centre of the beam has to incident on the centre of the array, the relationship between the amount of angular momentum discernible and the spatial proportion of the beam incident on the array is similar to the relationship already presented in the original application. For the purposes of explaining how the detection of angular momentum, we assume tht the entire beam is received and that the centre of the beam coincides with the centre of the array. The signal from each of the elements is processed in the following way, as illustrated in FIG. 16, the signals form the elements along the same azimuthal angle are added together with no phase delay. These summed signals are then added together with a programmable time delay. The time delay is related to the angular momentum, l, and the azimuthal angle, Φ, according to the expression given previously.

In other words the signals from elements along the same azimuthal angle are added together with no time delay. The signal from elements along different azimuthal angles are added together with a time delay determined by the magnitude of the angular momentum.

Each of the dipole antenna can be replaced with a double orthogonal dipole antenna. Driving the two dipoles with a fixed phase and amplitude ratio gives additional control to the polarization state. For example, driving the antenna with the same amplitude in phase quadrature results in circularly polarized electro-magnetic energy, e.g. light. Consequently, a double dipole antenna array of the type shown in FIG. 16 allow independent control of both the spin (i.e. polarization) and orbital angular momentum (i.e. phase) of the electro-magnetic energy, e.g. light beam. The same antenna array can also be used for detection of such energy, e.g. beams.

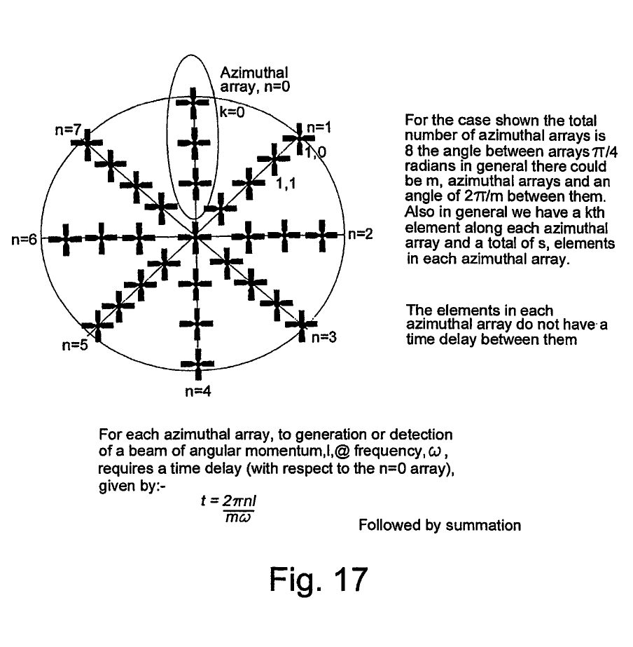

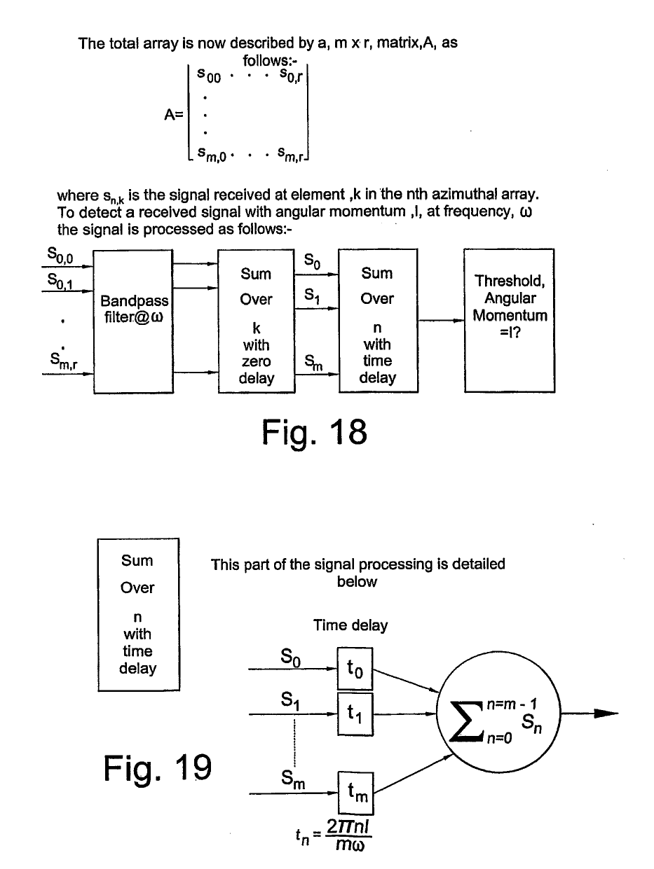

Referring now to FIGS. 17 and 18, there is illustrated a yet further embodiment of a system according to the present invention. For the case shown, the total number of azimuthal arrays is 8; the angle between the arrays π/4 radians; in general there could be m, azimuthal arrays and an angle of 2π/m between them. Also in general we have a kth element along each azimuthal array and a total of s elements in each azimuthal array. The elements in each azimuthal array do not have a time delay between them.

For each azimuthal array, to generate or detect a beam of angular momentum, l, at frequency, ω, requires a time delay (with respect to the n=O array), given by:—

$$t = \frac{2 π nl}{m ω}$$

Such is followed by summation.

The total array is now described by a, m×r, matrix, A, as follows:

$$A = [ \begin{matrix}{s}_{00} & … & {s}_{0 , r} \\ ⋮ & & \\ {s}_{m , 0} & … & {s}_{m , r}\end{matrix} ]$$

where s_{n,k} is the signal received at element k in the nth azimuthal array. To detect a received signal with angular momentum, l, at frequency, ω the signal is processed as shown in FIG. 18.

FIGS. 17 to 19 thus outline a scheme for signal processing a phased array of antenna to detect beams with a given angular momentum, l, at a frequency, ω.

It will be appreciated that the embodiments of the present invention hereinbefore described are given by way of example only, and that various modifications may be made to the arrangements as herein described. For example, in the absence of holograms, in a multi-device cascading arrangement, the device can be constructed to ‘sort’ beams where l takes on the values of 0 or 2ⁿ where n is an integer.

Furthermore, an arrangement such as that shown in FIG. 10 can be made omitting the quarter wave plates QP1 and QP2 and dealing only with a single polarisation, i.e. linear polarisation.

Another alternative in the arrangement of FIG. 9 is that the camera may be replaced with avalanche photo-diodes in order to detect, and therefore sort individual photons. In a further variation, each device may be provided with a multiple arm interferometer, which would allow each device to provide a ‘sorting’ ability according to the number of arms provided, for example, a three arm interferometer, would allow sorting into groups of a) 0, 3, 6, . . . , b) 1, 4, 7, . . . and c) 2, 5, 8, . . . .

It will also be appreciated that although some of the disclosed embodiments are described as optical devices, the invention is, by suitable adaptation of the embodiments capable of use within other regions of the electromagnetic spectrum, e.g. at radio frequencies or within the millimetre wave or microwave regions. A key advantage of the invention lies in that angular momentum of an electromagnetic signal, beam or wave can be encoded with information by switching between angular momentum states.

Finally, it will be appreciated that the present invention may find use in a number of technical fields, e.g. control or communications. The invention may, for example, find use in free space communications.

1-63. (canceled)

64. An electro-magnetic device comprising:
at least one input;
a plurality of outputs;
means for directing at least one electro-magnetic signal or photon from one of the at least one inputs to a selected one of the outputs, the selection being dependent upon at least an orbital angular momentum of the or each at least one electromagnetic signal or photon.

65. A device as claimed in claim 64, wherein the selection is dependent upon:
orbital angular momentum, l (OAM) solely;
orbital angular momentum and spin angular momentum, s (SAM) individually; or
orbital angular momentum and spin angular momentum combined, that is, total angular momentum, j.

66. An electro-magnetic device as claimed in claim 64, wherein the means for directing comprises at least one interferometer.

67. An electro-magnetic device as claimed in claim 66, wherein the or each interferometer includes means for inducing, in use, a rotation or inversion of an electromagnetic mode of an electro-magnetic signal such as light mode of a photon in at least one arm of the interferometer.

68. An electro-magnetic device as claimed in claim 64, wherein the device includes means for rotation of a polarisation state and hence spin angular momentum of a photon or photons.

69. An electro-magnetic device as claimed in claim 68, wherein the means for rotation allows an output of the device to be determined by total angular momentum of a photon or photons not solely by orbital angular momentum.

70. An electromagnetic device according to claim 64 which is an optical device.

71. An electromagnetic device according to claim 64 wherein the means for directing said at least one electro-magnetic signal is a phased-array antenna adapted to detect angular momentum in or of said at least one electro-magnetic signal.

72. An electro-magnetic device according to claim 71, wherein the device is adapted for use within a frequency range selected from one of: radio, a millimetre wave and microwave.

73. An apparatus comprising a plurality of cascaded devices, each device comprising:
at least one input;
a plurality of outputs;
means for directing at least one electro-magnetic signal or photon from one of the at least one inputs to a selected one of the outputs, the selection being dependent upon at least an orbital angular momentum of the or each at least one electromagnetic signal or photon,
wherein the devices are arranged with an at least one output of one device communicating with another device.

74. An apparatus as claimed in claim 73, wherein the apparatus comprises a signal processing apparatus.

75. An apparatus as claimed in claim 73, wherein the cascaded devices are optical devices and a hologram is disposed between an output of the one optical device and an input of the another optical device, so that, in use, the hologram acts to increase the orbital angular momentum of the or each photon which passes through the hologram.

76. A system including at least one device comprising:
at least one input;
a plurality of outputs;
means for directing at least one electro-magnetic signal or photon from one of the at least one inputs to a selected one of the outputs, the selection being dependent upon at least an orbital angular momentum of the or each at least one electromagnetic signal or photon,
said at least one device providing the system with at least two possible output groups of output photons or states, the groups or states being selected by the device depending on an orbital angular momentum feature of an input photon.

77. A system as claimed in claim 76, wherein the system is an optical communications system, such as a free space optical communication system.

78. A method of communication or signal processing comprising the steps of:
providing a device comprising:
at least one input;
a plurality of outputs;
means for directing an electro-magnetic signal from the at least one input to a selected one of the outputs, the selection being dependent upon an orbital angular momentum of the electro-magnetic signal;
inputting the electro-magnetic signal into the device; detecting a feature of the orbital angular momentum of the electro-magnetic signal; and
directing the electro-magnetic signal to a selected one of a plurality of outputs, the selected output for the electro-magnetic signal being selected by the detected property of the electro-magnetic signal.

79. A method of communication or signal processing according to claim 78 further including multiplexing using angular momentum of electro-magnetic beams by generation and sensing using phase differences in arrays of antennae.
